(19) United States
(12) Patent Application Publication
(10) Pub. No.: US 2023/0177831 A1
(43) Pub. Date: Jun. 8, 2023

(54) Dynamic User Interface and Data Communications Via Extended Reality Environment

(71) Applicant: Citrix Systems, Inc., Fort Lauderdale, FL (US)

(72) Inventor: Manbinder Pal Singh, Coral Springs, FL (US)

(21) Appl. No.: 17/540,509

(22) Filed: Dec. 2, 2021

(51) Int. Cl. G06V 20/20; G06V 10/774; G06V 30/10; G06F 3/04815; G06F 3/147; G06F 9/451; G06Q 20/34; H04L 9/40; G06N 20/00

(52) U.S. Cl. CPC G06V 20/20; G06V 10/7747; G06V 30/10; G06F 3/04815; G06F 3/147; G06F 9/451; G06Q 20/356; H04L 63/0838; G06N 20/00; G06V 2201/02

(57) ABSTRACT

Methods and systems for entering content into fields via an extended reality (XR) environment are described herein. An XR device may provide an XR environment. The XR device may detect, in a physical environment around the XR device, a user interface element, displayed by a display device, that permits entry of content by a user of a first computing device. The XR device may determine a type of content to be entered via the user interface element. The XR device may receive an image of a physical object corresponding to the type of content to be entered via the user interface element. The XR device may then process the image of the physical object to determine first content to provide to the user interface element and transmit, to the first computing device, the first content for entry into the user interface element.

### FIELD

Aspects described herein generally relate to extended reality (XR), such as virtual reality, augmented reality, and/or mixed reality, and hardware and software related thereto. More specifically, one or more aspects describe herein provide ways in which an XR environment, provided by an XR device, may be used to extend a user interface in combination with one or more other computing devices.

### BACKGROUND

A user may be prompted to provide input to one or more user interface elements displayed by a computing device. For example, to log in to a website, a user may be presented with a form prompting the user to enter their username and password into different fields. As another example, a user may be prompted to pay for items on an online shopping website by entering their payment card information into a secure form. This process can introduce security risks, be time-consuming, and generally might not be ideal for many users. For example, the process of typing in a particularly lengthy password into a log-in form may be cumbersome, error-prone, and annoying to a user. As another example, in the case where the form requires that a user enter a one-time-use passcode from their smartphone, the process of the user finding, accessing, and typing out the content from their smartphone on to another device may be cumbersome, time-limited, and error-prone.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

XR display devices provide users many different types of XR environments (e.g., a virtual reality environment, an augmented reality environment, and/or a mixed reality environment). For example, a worker in an office may use augmented reality glasses to display content on top of real-world content visible through the lens of the glasses. In this manner, the worker may be able to interact with real-world, physical objects (e.g., paper, laptops, etc.) while also interacting with virtual objects in the XR environment (e.g., three-dimensional content displayed on a display of an XR device).

To overcome limitations in the prior art described above, and to overcome other limitations that will be apparent upon reading and understanding the present specification, aspects described herein are directed towards providing content for entry in user interface elements via an XR environment. A user may operate a first computing device (e.g., a laptop, desktop, or the like) and be prompted to enter content (e.g., a password, a payment card number) into a user interface element. That user interface element may be displayed by a display device, such as a computer monitor. An XR device may detect this user interface element (by, e.g., capturing an image of the display device and/or by receiving information about user interface elements from an external source, such as from a second computing device displaying the user interface element on a display screen), then determine one or more properties of the user interface element. These properties may indicate what sort of content the user interface element asks for (e.g., if the user interface element asks for a password, a credit card number, or the like). The XR device may then capture images of a physical environment around the XR device, and then use those images to determine content for entry in the user interface element. For example, if a credit card is on a nearby desk, the XR device may capture an image of the credit card, determine the credit card number(s) using an Optical Character Recognition (OCR) algorithm, and then provide those numbers to the first computing device for input into the user interface element.

As will be described further herein, an XR device may provide, to a user, an XR environment. The XR device may comprise, for example, an XR device, such as a virtual reality headset, augmented reality glasses, or the like. The XR device may detect, in a physical environment around the XR device, a user interface element, displayed by a display device, that permits entry of content by a user of a first computing device. For example, the XR device may capture, using one or more cameras of the XR device, one or more images of the display device. The XR device may determine, based on one or more properties of the user interface element, a type of content to be entered via the user interface element. The XR device may receive an image of a physical object, in the physical environment around the XR device, corresponding to the type of content to be entered via the user interface element. For example, the XR device may capture, via one or more cameras of the XR device, text displayed by a second display device of a second computing device. The XR device may process the image of the physical object to determine first content to provide to the user interface element. The XR device may then transmit, to the first computing device, the first content for entry into the user interface element. For example, the XR device may transmit, to the first computing device, data that causes the first computing device to automatically provide the first content to the user interface element.

The process described herein may leverage machine learning algorithms. For example, the XR device may train, using training data, a machine learning model to detect images of physical objects corresponding to the type of content in a plurality of different physical environments. The training data may comprise a plurality of different images of the physical objects. Then, as part of detecting the physical object, the XR device may provide, to the trained machine learning model, one or more images corresponding to the physical environment and receive output from the trained machine learning model. That output may comprise information about one or more physical objects in the physical environment. For example, the output may comprise information such as a location of one or more physical objects (e.g., one or more bounding boxes associated with a location of the one or more physical objects), a type of the physical objects (e.g., whether the one or more physical objects correspond to a credit card, driver's license, smartphone), or the like. Using information such as the aforementioned bounding boxes and/or physical object types, a portion of an image corresponding to a physical object may be identified.

Processing the image of the physical object may comprise determining text and/or similar content via the physical object. For example, the XR device may process, using an optical character recognition algorithm, text in the image of the physical object. The first content may, in such a circumstance, comprise at least a portion of the text in the image.

The process described herein may be automatic (e.g., such that form entry may be performed without user interaction) and/or may be manual (e.g., based on user interaction). For example, the XR device may provide, via the XR environment and/or anther computing device, a second user interface element. Then, the XR device may receive, via the XR environment and/or the another computing device, user input corresponding to the second user interface element. In this situation, transmitting the first content may be based on the user input.

The process described herein may be used in a wide variety of different circumstances. As one example, the process described herein may be used to enter payment card numbers into forms. The XR device may, for example, determine that the user interface element corresponds to entry of a payment card number. In this circumstance, the type of content may comprise a string of numbers, and the one or more properties of the user interface element may comprise a label associated with the user interface element. As another example, the process described herein may be used to enter a password into a form. The XR device may, for example, determine that the user interface element corresponds to entry of a password. In such a circumstance, the type of content may comprise a string of characters, and the one or more properties of the user interface element may comprise a location of the user interface element. As yet another example, the process described herein may be used to enter a one-time-use code (e.g., as received via a text message sent to a smartphone) into a form. The XR device may, for example, determine that the user interface element corresponds to entry of a one-time-use code. In such a circumstance, the type of content may comprise a string of characters, and the image of the physical object may indicate content displayed by a text messaging application.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative extended reality (XR) device.

FIG. 3 depicts an XR device connected to computing devices via a network.

FIG. 4 depicts a physical environment about an XR device, including user interface elements displayed by computing devices nearby the XR device.

FIG. 5 depicts a flow chart for providing content to user interface elements via an XR environment.

FIG. 6A depicts a physical notepad with a password written thereon.

FIG. 6B depicts a physical transaction card.

FIG. 6C depicts a computing device displaying a one-time password.

FIG. 7 depicts an example deep neural network architecture for a model according to one or more aspects of the disclosure.

FIG. 8 depicts a messaging diagram for providing content to user interface elements via an XR environment.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards using XR devices (e.g., virtual reality headsets, augmented reality glasses) to provide content to user interface elements displayed by different computing devices. In this manner, for example, a user may use their augmented reality device to automatically fill their credit card details into a user interface element presented by a nearby laptop, smartphone, desktop, or the like. This has numerous advantages. The process described herein avoids users saving sensitive information (e.g., their passwords, credit card numbers) on computing devices, thereby better avoiding the risk of data breach. The process described herein also avoids forcing users to repetitively manually enter in information into user interface elements, such that, for example, a user need not repeatedly enter their password into a form multiple times a day. The process described herein is also more accurate than manual typing by users, particularly where the content to be entered into a user interface element is lengthy or convoluted (as may be the case with a password). The process described herein also allows users to readily transfer data (e.g., one-time passwords texted to their smartphones) from one device (e.g., a smartphone) to another device (e.g., a laptop requesting the one-time password) with relative ease.

As will be discussed in greater detail below, the present disclosure has a large number of improvements over conventional approaches to entering data into user interface elements of forms displayed by computing devices. Typically, users must manually type (e.g., with a physical or virtual keyboard) content into certain types of user interface elements. This process can be laborious, particularly when the information input into the element(s) is lengthy and/or repetitive. Some form designers attempt to make this process easier by allowing different forms of data entry (e.g., scroll wheels for dates, radio options to select from one of a number of predetermined options, capturing an image using a camera of a smartphone), but these approaches typically do not improve the process of entry of particularly sensitive data (e.g., passwords, payment card numbers, and the like).

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect connecting and coupling.

### Computing Architecture

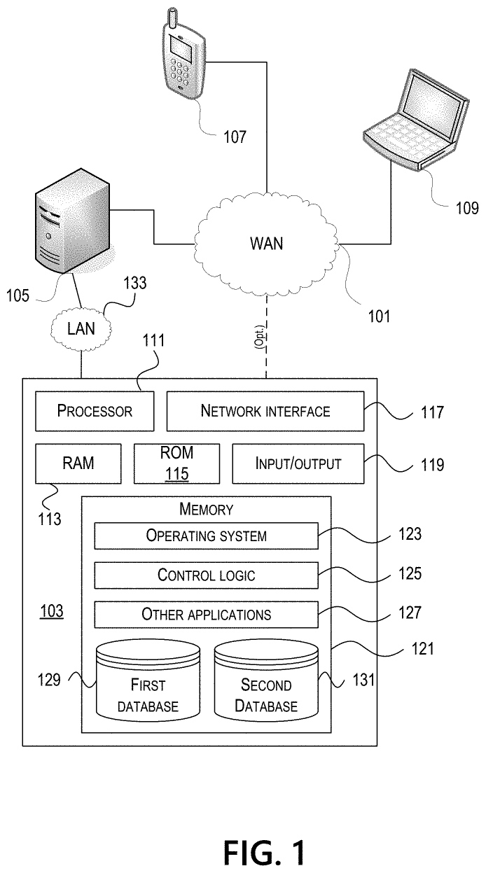

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

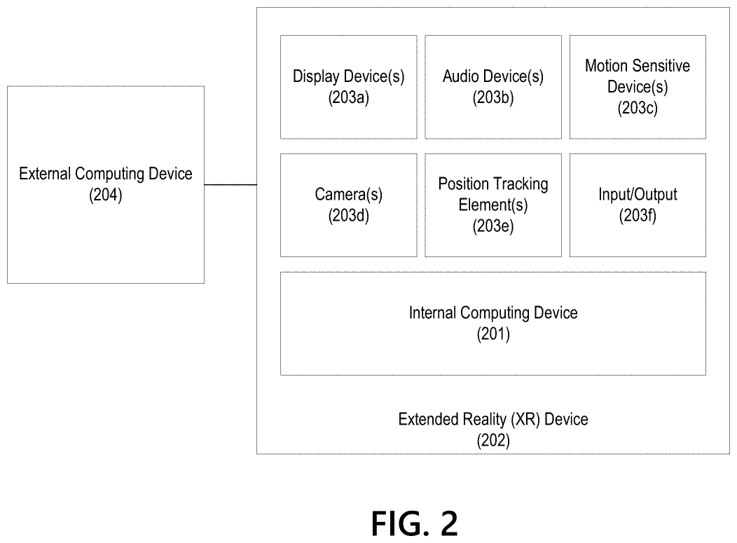

FIG. 2 depicts an example of an XR device 202. The XR device 202 may be configured to provide a XR environment (e.g., a virtual reality (VR), augmented reality (AR), and/or mixed reality (MR) environment). The XR device 202 may be communicatively connected to a external computing device 204, which may be the same or similar as one or more of the devices 103, 105, 107, and 109. The XR device 202 may comprise a plurality of different elements, such as display devices 203a, audio devices 203b, motion sensitive devices 203c, cameras 203d, position tracking elements 203e, and input/output 203f. Such elements may additionally and/or alternatively be referred to as sensors. Other such elements, not shown, may include in-ear electroencephalographic (EEG) and/or heart rate variability (HRV) measuring devices, scalp and/or forehead-based EEG and/or HRV measurement devices, eye-tracking devices (e.g., using infrared), or the like. The XR device 202 may further comprise a internal computing device 201, which may be the same or similar as the devices 103, 105, 107, and 109. Not all elements shown in FIG. 2 need to be present for operation of the XR device 202. For example, the XR device 202 may lack an internal computing device 201, such that the external computing device 204 may directly interface with the display devices 203a, the audio devices 203b, the motion sensitive devices 203c, the cameras 203d, the position tracking elements 203e, and/or the input/output 203f to provide an XR environment. As another example, the internal computing device 201 may be sufficiently powerful enough such that the external computing device 204 may be omitted. Though the internal computing device 201 and external computing device 204 use the terms internal and external for the purposes of illustration in FIG. 2, these devices need not be, for example, located within or outside of housing of the XR device 202. For example, the external computing device 204 may be physically mounted to the XR device 202, a user of the XR device 202, or the like. As another example, the internal computing device 201 may be physically distant from other elements of the XR device 202 and, e.g., connected to those elements by a long cable.

The external computing device 204 and/or the internal computing device 201 need not have any particular processing power or functionality to provide an XR environment. The external computing device 204 and/or the internal computing device 201 may comprise, for example, relatively underpowered processors which provide rudimentary video and/or audio. Alternatively, the external computing device 204 and/or the internal computing device 201 may, for example, comprise relatively powerful processors which provide highly realistic video and/or audio. As such, the external computing device 204 and/or the internal computing device 201 may have varying levels of processing power.

The XR device 202 may provide a VR, AR, and/or MR environment to the user. In general, VR environments provide an entirely virtual world, whereas AR and/or MR environments mix elements in the real world and the virtual world. The XR device 202 may be a device specifically configured to provide an XR environment (e.g., a VR headset), or may be a combination of devices (e.g., a smartphone inserted into a headset) which, when operated in a particular manner, provides an XR environment. The XR device 202 may be said to be untethered at least in part because it may lack a physical connection to another device (and, e.g., may be battery powered). If the XR device 202 is connected to another device (e.g., the external computing device 204, a power source, or the like), it may be said to be tethered. Examples of the XR device 202 may include the VALVE INDEX VR device developed by Valve Corporation of Bellevue, Wash., the OCULUS QUEST VR device sold by Facebook Technologies, LLC of Menlo Park, Calif., and the HTC VIVE VR device sold by HTC Corporation of New Taipei City, Taiwan. Examples of the XR device 202 may also include smartphones which may be placed into a headset for VR purposes, such as the GEAR VR product sold by Samsung Group of Seoul, South Korea. Examples of the XR device 202 may also include the AR headsets sold by Magic Leap, Inc. of Plantation, Fla., the HOLOLENS MR headsets sold by Microsoft Corporation of Redmond, Wash., and NREAL LIGHT headsets sold by Hangzhou Tairuo Technology Co., Ltd. of Beijing, China, among others. Examples of the XR device 202 may also include audio-based devices, such as the ECHO FRAMES sold by Amazon, Inc. of Seattle, Wash.. All such VR devices may have different specifications. For example, some VR devices may have cameras, whereas others might not. These are merely examples, and other AR/VR systems may also or alternatively be used.

The external computing device 204 may provide all or portions of an XR environment to the XR device 202, e.g., as used by a tethered OCULUS RIFT. For example, the external computing device 204 may provide a video data stream to the XR device 202 that, when displayed by the XR device 202 (e.g., through the display devices 203a), shows a virtual world. Such a configuration may be advantageous where the XR device 202 (e.g., the internal computing device 201 that is part of the XR device 202) is not powerful enough to display a full XR environment. The external computing device 204 need not be present for the XR device 202 to provide an XR environment. For example, where the internal computing device 201 is sufficiently powerful, the external computing device 204 may be omitted, e.g., an untethered OCULUS QUEST.

The display devices 203a may be any devices configured to display all or portions of an XR environment. Such display devices 203a may comprise, for example, flat panel displays, such as one or more liquid-crystal display (LCD) panels. The display devices 203a may be the same or similar as the display 106. The display devices 203a may be singular or plural, and may be configured to display different images to different eyes of a user. For example, the display devices 203a may comprise one or more display devices coupled with lenses (e.g., Fresnel lenses) which separate all or portions of the displays for viewing by different eyes of a user.

The audio devices 203b may be any devices which may receive and/or output audio associated with an XR environment. For example, the audio devices 203b may comprise speakers which direct audio towards the ears of a user. As another example, the audio devices 203b may comprise one or more microphones which receive voice input from a user. The audio devices 203b may be used to provide an audio-based XR environment to a user of the XR device 202.

The motion sensitive devices 203c may be any elements which receive input related to the motion of a user of the XR device 202. For example, the motion sensitive devices 203c may comprise one or more accelerometers which may determine when a user of the XR device 202 is moving (e.g., leaning, moving forward, moving backwards, turning, or the like). Three dimensional accelerometers and/or gyroscopes may be used to determine full range of motion of the XR device 202. Optional external facing cameras, which may be all or portions of the cameras 203d, may be used for 3D orientation as well. The motion sensitive devices 203c may permit the XR device 202 to present an XR environment which changes based on the motion of a user. The motion sensitive devices 203c may additionally and/or alternatively comprise motion controllers or other similar devices which may be moved by a user to indicate input. As such, the motion sensitive devices 203c may be wholly or partially separate from the XR device 202, and may communicate via the input/output 203f.

The cameras 203d may be used to aid in the safety of the user as well as the presentation of an XR environment. The cameras 203d may be configured to capture images of one or more portions of an environment around the XR device 202. The cameras 203d may be used to monitor the surroundings of a user so as to avoid the user inadvertently contacting elements (e.g., walls) in the real world. The cameras 203d may additionally and/or alternatively monitor the user (e.g., the eyes of the user, the focus of the user's eyes, the pupil dilation of the user, or the like) to determine which elements of an XR environment to render, the movement of the user in such an environment, or the like. As such, one or more of the cameras 203d may be pointed towards eyes of a user, whereas one or more of the cameras 203d may be pointed outward towards an environment around the XR device 202. For example, the XR device 202 may have multiple outward-facing cameras that may capture images, from different perspectives, of an environment surrounding a user of the XR device 202.

The position tracking elements 203e may be any elements configured to aid in the tracking of the position and/or movement of the XR device 202. The position tracking elements 203e may be all or portions of a system of infrared emitters which, when monitored by a sensor, indicate the position of the XR device 202 (e.g., the position of the XR device 202 in a room). The position tracking elements 203e may be configured to permit “inside-out” tracking, where the XR device 202 tracks the position of one or more elements (e.g., the XR device 202 itself, a user's hands, external controllers, or the like) or “outside-in” tracking, where external devices aid in tracking the position of the one or more elements.

The input/output 203f may be configured to receive and transmit data associated with an XR environment. For example, the input/output 203f may be configured to communicate data associated with movement of a user to the external computing device 204. As another example, the input/output 203f may be configured to receive information from other users of in multiplayer XR environments.

The internal computing device 201 and/or the external computing device 204 may be configured to provide, via the display devices 203a, the audio devices 203b, the motion sensitive devices 203c, the cameras 203d, the position tracking elements 203e, and/or the input/output 203f, the XR environment. The internal computing device 201 may comprise one or more processors (e.g., a graphics processor), storage (e.g., that stores virtual reality programs), or the like. In general, the internal computing device 201 may be powerful enough to provide the XR environment without using the external computing device 204, such that the external computing device 204 need not be required and need not be connected to the XR device 202. In other configurations, the internal computing device 201 and the external computing device 204 may work in tandem to provide the XR environment. In other configurations, the XR device 202 might not have the internal computing device 201, such that the external computing device 204 interfaces with the display devices 203a, the audio devices 203b, the motion sensitive devices 203c, the cameras 203d, the position tracking elements 203e, and/or the input/output 203f directly.

The above-identified elements of the XR device 202 are merely examples. The XR device 202 may have more or similar elements. For example, the XR device 202 may include in-ear EEG and/or HRV measuring devices, scalp and/or forehead-based EEG and/or HRV measurement devices, eye-tracking devices (e.g., using cameras directed at users' eyes, pupil tracking, infrared), or the like.

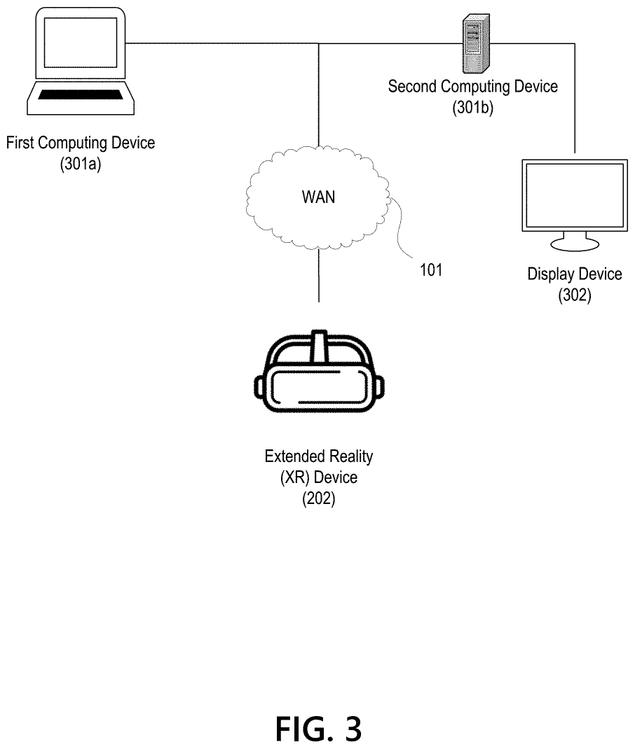

FIG. 3 shows the XR device 202 connected, via the network 101, first computing device 301a (e.g., a laptop computer) and a second computing device 301b (e.g., a desktop computer). The first computing device 301a and/or the second computing device 301b may be a computing device the same or similar as the devices 103, 105, 107, and 109. Additionally and/or alternatively, the first computing device 301a and/or the second computing device 301b may be the same or similar as the external computing device 204. The second computing device 301b is shown as being connected to a display device 302, which may be external to the second computing device 301b. The first computing device 301a may itself comprise a display device, such as a screen. In this manner, FIG. 3 illustrates that the XR device 202 may be surrounded by various types of computing devices, which may display content on a wide variety of different display devices. For instance, any one of the display devices may display one or more user interface elements.

In some cases, the XR device 202 may be communicatively coupled to one or more computing devices (e.g., the first computing device 301a and/or the second computing device 301b), such that those computing devices act as the external computing device 204. Those computing devices might also display, on a display device separate from the XR device 202, a user interface element. For example, the second computing device 301b might provide XR environment information to the XR device 202 while simultaneously displaying, on the display device 302, a user interface element in a web browser.

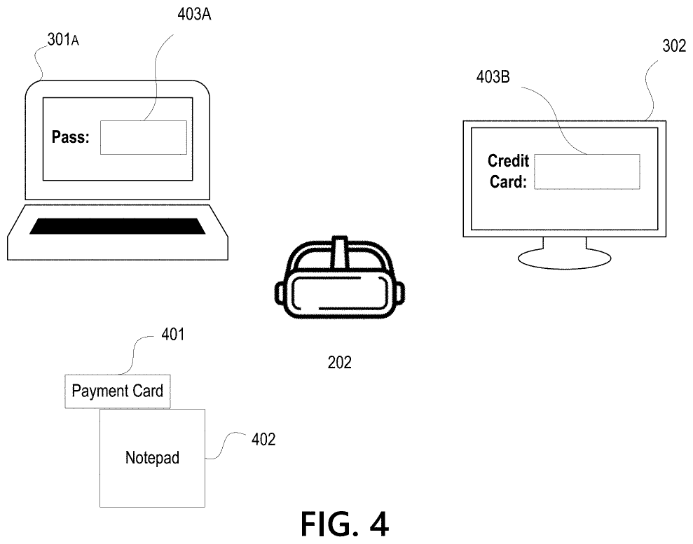

FIG. 4 depicts an illustrative physical environment around the XR device 202. Depicted in FIG. 4 is the XR device 202, the first computing device 301a, the display device 302, a payment card 401, and a notepad 402. A display of the first computing device 301a is showing a first user interface element 403a, which asks for a password. The display device 302 is showing a second user interface element 403b, which asks for a credit card number. The payment card 401 may have a credit card number written on it, whereas the notepad 402 may have a password written on it. As such, the content to be input to the first user interface element 403a may be written on the notepad 402, whereas the content to be input to the second user interface element 403b may be on the payment card 401.

### Dynamic User Interface and Data Communications Via Extended Reality Environments

Having discussed several examples of computing devices, display devices, and XR devices which may be used to implement some aspects as discussed further below, discussion will now turn to how user interfaces (e.g., the first user interface element 403a and/or the second user interface element 403b) may be extended via an XR environment (e.g., provided by the XR device 202).

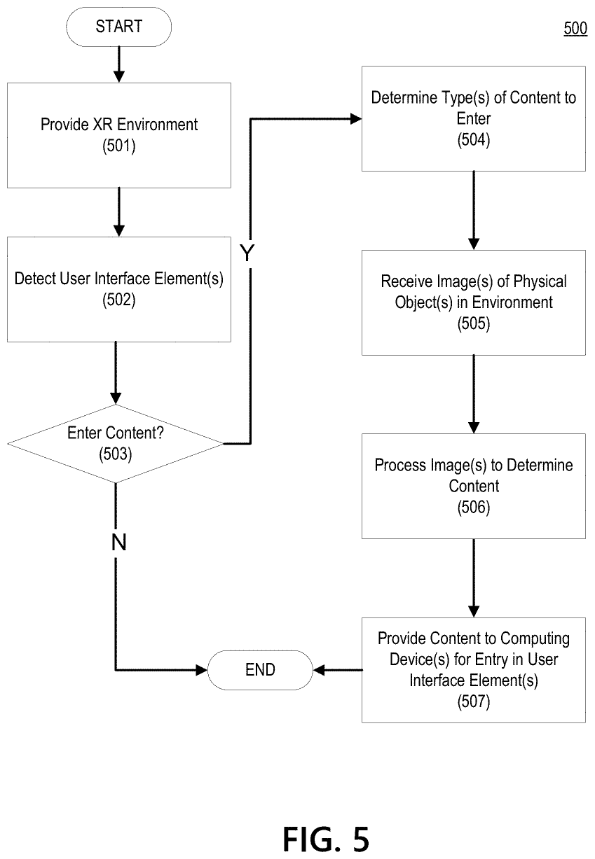

As a preliminary example of the process described by FIG. 5, a user may wear an XR device (e.g., the XR device 202) while working on their desktop computer (e.g., the second computing device 301b). As part of that work, the user may be prompted in a user interface (e.g., displayed on the display device 302) to enter content into a user interface element (e.g., a text field requesting a password). Aspects described herein relate to detecting that user interface element, then capturing images of the user's physical environment and detecting whether content (e.g., a password) can be filled. For example, the XR device may capture images of a nearby sticky note that indicates a password. The XR device may then, using an OCR algorithm, determine the content of that password, then transmit instructions to the desktop computer (e.g., the second computing device 301b) that causes the desktop computer to automatically enter that content into the user interface element.

FIG. 5 depicts a flow chart depicting steps of a method 500 for implementing field entry via XR environments. The steps shown in FIG. 5 may be performed by all or portions of a computing device, such as the XR device 202, the external computing device 204, the internal computing device 201, and/or the like. A computing device comprising one or more processors and memory storing instructions may be configured such that the instructions, when executed, cause performance of one or more of the steps of FIG. 5. The steps depicted in FIG. 5 are illustrative, and may be rearranged or omitted as desired.

In step 501, a computing device (e.g., the XR device 202 or some portion thereof, such as the external computing device 204 and/or the internal computing device 201) may provide an XR environment. The computing device may comprise all or portions of an XR device, such as the XR device 202. For example, the computing device may provide, via an XR device and to a user, an XR environment. The XR device may comprise one or more objects. The one or more objects may comprise virtual objects, such as objects that may be generated by either or both the external computing device 204 and/or the internal computing device 201. The one or more objects may comprise real-life objects, such as may be displayed via a video feed captured by the cameras 203d and displayed via the display devices 203a. Additionally and/or alternatively, such as where the XR device is a set of glasses or semi-transparent device, the real life, physical objects may be displayed in circumstances where the XR device 202 does not prevent their view through transparent glass or the like. As such, the XR environment may comprise one or more virtual objects (e.g., a virtual user interface) and one or more real objects (e.g., physical objects in a physical environment about the user).

In step 502, the computing device may detect one or more user interface elements. The one or more user interface elements may be detected on one or more display devices separate from the XR device 202. For example, the computing device may detect, in a physical environment around the XR device, a user interface element, displayed by a display device, that permits entry of content by a user of a first computing device. In this manner, the user interface element itself may be displayed by an entirely different computing device as compared to the computing device(s) (e.g., the XR device 202) providing the XR environment. The user interface element may be detected using one or more cameras (e.g., the cameras 203d of the XR device 202), and may be detected by capturing images of content displayed by one or more display devices (e.g., display devices associated with the first computing device 301a and/or the second computing device 301b, such as the display device 302). For example, the computing device may capture, using one or more cameras of the XR device (e.g., the cameras 203d of the XR device 202), one or more images of the display device. Because the images of the display device may be skewed or otherwise imperfect (e.g., because the cameras 203d of the XR device 202 might not be exactly square to a particular display device), as part of step 502, the images of the display device may be corrected in terms of perspective. Additionally and/or alternatively, further image processing of the images of the display device may be performed. For example, color correction, perspective correction, contrast correction, and/or other steps may be performed to the images of the display device.

Detecting the one or more user interface elements may comprise receipt of information about the one or more user interface elements from one or more computing devices. For example, the computing device may receive, from a second computing device, information about one or more user interface elements displayed by the second computing device. In this manner, information about the user interface elements (e.g., HTML code used to display those user interface elements) may be communicated, via a network, between computing devices. As such, as part of step 502, the computing device may receive all or portions of code used to display the user interface elements.

Detecting the one or more user interface elements may comprise detecting that a display device is requesting entry of content. Accordingly, the user interface elements may comprise text boxes, checkboxes, a list of items from which the user is asked to select from, or the like. As such, detecting the one or more user interface elements may comprise detecting that a display device is showing a Hypertext Markup Language (HTML) form field or similar text entry box. That said, because user interface elements may vary wildly in terms of styling, sizing, and the like, the particular detection of a user interface element may vary.

Detecting the one or more user interface elements may comprise detecting a bounding box corresponding to a user interface element. Certain user interface elements (e.g., text fields) may be substantially rectangular in shape and have defined borders. In such a circumstance, detecting the one or more user interface elements may comprise detecting, in one or more images, a bounding box corresponding to at least one user interface element.

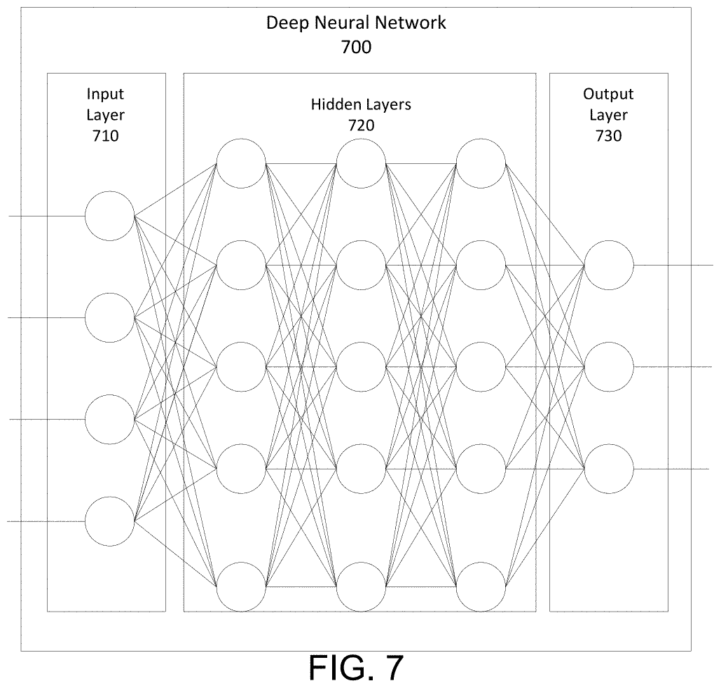

Detecting the one or more user interface elements may comprise use of a machine learning model. A machine learning model may be implemented via a neural network, such as that described below with respect to FIG. 7. A computing device may train, using training data, a machine learning model to detect user interface elements displayed on display devices. The training data may comprise a plurality of different images of display devices that display different types of content, such as one or more different types of user interfaces. The computing device may provide, to the trained machine learning model, one or more images corresponding to a display device. The computing device may then receive, as output from the trained machine learning model, an indication of whether the display device comprises one or more user interface elements.

Detecting the one or more user interface elements may comprise processing HTML data corresponding to the user interface element. For example, where the computing device has access to HTML displayed by a display device, then the computing device may process the HTML to identify tags (e.g., “<input>” tags) corresponding to user interface elements. In this process, additional information in the HTML might indicate one or more properties of the user interface element(s). For example, if an “<input>” tag (e.g., “<input type=”password”>”) is specified as associated with a password in HTML code, then that may strongly suggest that the user interface element is configured to receive a password.

In step 503, the computing device may determine whether content should be entered into the one or more user interface elements detected in step 502. In some instances, user interface elements might not require and/or need content entry. For example, if content is already input into a user interface element, then there may be no need to add additional content to that user interface element. As another example, if a user interface element is optional, then there may be no need to add additional content to that user interface element. If content should be entered into the one or more user interface elements, the method 500 proceeds to step 504. Otherwise, the method 500 ends.

Detecting whether a user interface element might not need content entry may be based on processing of images determined during step 502. For example, if a region of a display device associated with a user interface element comprises alphanumeric characters, that may indicate that content is already entered into the user interface element. As another example, if a region of a display device associated with a user interface element comprises a label (e.g., some alphanumeric text nearby the user interface element denoting properties of the user interface element) indicating that the user interface element is optional, then that may indicate that the user interface element need not be provided content. As a particular example, a form comprising multiple user interface elements may be displayed by a display device, with some user interface elements in that form associated with an asterisk. While user interface elements with an asterisk may be required, user interface elements without such an asterisk may be optional. In such a circumstance, if the computing device does not detect an asterisk associated with a particular user interface element, this may indicate that the particular user interface element is optional.

In step 504, the computing device may determine one or more types of content to enter into the one or more user interface elements detected in step 502. The one or more types of content to enter into the one or more user interface elements may be based on properties of the user interface element(s). For example, the computing device may determine, based on one or more properties of the user interface element, a type of content to be entered via the user interface element. In this manner, the content ultimately determined to be entered into the user interface element may be based on the properties of that user interface element. For example, based on a user interface element being configured to receive a month, day, and year, the type of content to be entered via the user interface element might be a month, day, and year.

A property of a user interface element may be any information associated with the user interface element that indicates a type of content for entry into the user interface element. Some user interface elements may comprise a label, such as descriptive text that indicates information about a user interface element, such as a type of content requested via the user interface element. As a simple example, a password field may be associated with a label that says “Password:” or the like. In such a circumstance, this label may indicate a type of content to be entered into the user interface element (e.g., alphanumeric text corresponding to a password for a particular service). The shape and/or size of a user interface element may be another type of property indicating the type of content to be entered by a user interface element. For example, a set of four sequential fields for entry of short characters may indicate a request for a credit card number (which may comprise four sets of four numbers). As another example, an HTML textarea field may indicate a request for lengthy quantities of alphanumeric text. The location of a user interface element may be another type of property indicating the type of content to be entered by a user interface element. For example, two user interface elements of similar length, followed by a “Log In” button, may comprise a username and password field. As another example, a lengthy user interface element at the top of a web browser application may be a Uniform Resource Locator (URL) field. As yet another example, type attributes of the HTML “input” tag may provide information about the type of data requested (such that, for example, “type=‘password’” may indicate a request for a password).

As one example of a type of content, the type of content to enter into a particular user interface element may correspond to a payment card number. For example, a web form may request that a user provide their credit card number to complete an online order. As such, the computing device may, for example, determine that a user interface element corresponds to entry of a payment card number. To make such a determination, the computing device may have processed one or more properties of the user interface element that indicate that the user interface element is configured to receive payment card information. For example, the one or more properties of the user interface element may comprise a label associated with the user interface element that says “Credit Card Number:” or the like. In that circumstance, the type of content may comprise a string of numbers (e.g., four sets of four digits).

As another example of a type of content, the type of content to enter into a particular user interface element may correspond to a password. The computing device may, for example, determine that the user interface element corresponds to entry of a password. To make such a determination, the computing device may have processed an image of a display device and noticed that the user interface element is positioned in a location associated with a password (e.g., immediately under a username field). As such, the one or more properties of the user interface element may comprise a location of the user interface element. In that circumstance, the type of content may comprise a string of characters.

As another example of a type of content, the type of content to enter into a particular user interface element may correspond to a one-time password. A field may request a one-time password as a form of two-factor authentication. The computing device may determine that the user interface element corresponds to entry of a one-time-use code. In that circumstance, the type of content may comprise a string of alphanumeric characters. Moreover, the image of the physical object may comprise content from another display device, such as the display device from a smartphone that displays a text messaging application. In turn, the image of the physical object may indicate content displayed by a text messaging application.

In step 505, the computing device may receive one or more images of one or more physical objects in a physical environment. A physical object may be any object in the physical environment around an XR device (e.g., the XR device 202). For example, as shown in FIG. 3, such physical objects may comprise the payment card 401 and/or the notepad 402. Additionally and/or alternatively, the physical object may comprise display devices, such as the display of a nearby smartphone, a nearby television screen, or the like.

The one or more images of the one or more physical objects received in step 505 may correspond to the user interface elements detected in step 502. For example, the computing device may receive an image of a physical object, in the physical environment around the XR device, corresponding to the type of content to be entered via the user interface element. As part of this process, many different images of a physical environment may be captured, and different objects may be isolated from those images using, for example, an object recognition algorithm. For example, ten different images of a physical environment of a user may be captured, and different objects that may comprise information relevant to a user interface element (e.g., the payment card 401, the notepad 402) may be isolated from objects that are unlikely to comprise information relevant to a user interface element (e.g., a chair, a desk). As will be described below, additionally and/or alternatively, a single image containing all the physical objects may be processed by a machine learning model, and that machine learning model may be configured to perform object detection and segmentation to thereby identify physical object(s) (including, e.g., their type and/or location).

Receiving the one or more images may comprise receipt of the one or more images via one or more cameras, such as the cameras 203d of the XR device 202. For example, the computing device may capture, via one or more cameras 203d, text displayed by a second display device of a second computing device. As another example, the computing device may capture, via one or more cameras, text printed on material (e.g., a credit card, a notebook, a sticky note) visible to the cameras.

Receiving the one or more images of the one or more physical objects in the physical environment may comprise use of a machine learning model. A machine learning model may be implemented via a neural network, such as that described below with respect to FIG. 7. A computing device may train, using training data, a machine learning model to detect images of physical objects corresponding to the type of content in a plurality of different physical environments. The training data may comprise a plurality of different images of the physical objects. The computing device may provide, to the trained machine learning model, one or more images corresponding to the physical environment. The computing device may then receive, as output from the trained machine learning model, the image of the physical object. For example, the output may comprise an indication of a location of an object (e.g., a bounding box indicating the location of the object) and a type of the object (e.g., an indication of what the object is predicted to be).

In step 506, the computing device may process the one or more images received in step 505 to determine content. Processing the one or more images may comprise executing one or more algorithms to determine content (e.g., alphanumeric text, images) that may be entered into one or more user interface elements. For example, the computing device may process the image of the physical object to determine first content to provide to the user interface element. In this manner, the nature of a user interface element may be used to determine (e.g., map) objects to look for in the one or more images received in step 505.

The content may comprise alphanumeric text, such as may be entered into a user interface element that comprises a text field. For example, the computing device may process, using an optical character recognition algorithm, text in the image of the physical object. In that circumstance, the content for entry in a user interface element may comprise at least a portion of the text in the image.

The content may comprise an image, such as may be entered into a user interface element that comprises an image upload functionality. For example, the computing device may use one or more object recognition algorithms to determine one or more objects in an image of the physical object. In that circumstance, the content for entry in a user interface element may comprise at least a portion of the image of the physical object. In this way, for example, a user may be able to provide an image of their identification card responsive to being prompted, by a user interface element, to provide an image of their identification card.

As two examples of the process described above, a user might want to capture content from both a credit card as well as a vaccination card. In the case of the credit card, the computing device may use one or more object recognition algorithms to detect the credit card, then use optical character recognition algorithms to detect the content on the card (e.g., a credit card number). In contrast, in the case of the vaccination card, the computing device may use one or more object recognition algorithms to detect the vaccination card, but need not necessarily use any optical character recognition algorithms (as, in that case, it might only be necessary that an image of the vaccination card be captured and uploaded via a form).

In step 507, the computing device may provide the content determined in step 506 to one or more computing devices for entry into the one or more user interface elements detected in step 502. In this manner, the computing device itself need not fill out the user interface element: rather, the computing device may instruct a different computing device (e.g., the computing device displaying the one or more user interface elements via a display device) to enter the content into the appropriate user interface element(s). For example, the computing device may transmit, to the first computing device, the first content for entry into the user interface element. This transmission may entail causing the first computing device to perform steps with respect to a particular user interface element. For example, the computing device may transmit, to the first computing device, data that causes the first computing device to automatically provide the first content to the user interface element.

Providing the content may be contingent, in whole or in part, on user involvement. For example, the computing device may provide, via the XR environment, a second user interface element. That second user interface element may be virtual and displayed in the XR environment. For example, the computing device may cause display, in the XR environment, of an option (e.g., “Fill In Form Automatically?”) that allows a user to select whether they want their credit card number automatically input into a particular user interface element. The computing device may then receive, via the XR environment, user input corresponding to the second user interface element. Based on that user input, the content may or might not be provided. Additionally and/or alternatively, the user involvement may be implemented via a different computing device. For example, the user interface element may be provided by a second computing device, and the second computing device may provide a second user interface element that asks the user whether they would like to retrieve content from the XR environment. In this manner, a user may provide consent for the user interface element to be completed via the computing device upon which the user interface element is displayed.

One advantage of the process depicted in FIG. 5 is that it may help avoid circumstances where a user may otherwise store/transmit confidential information, such as images of their credit card and/or plain text passwords. For example, by using an XR device to capture images of a credit card and provide the numbers of the credit card to a different computing device, a user might be thereby discouraged from saving the plain text information of their credit card numbers in, for example, a text file on their desktop.

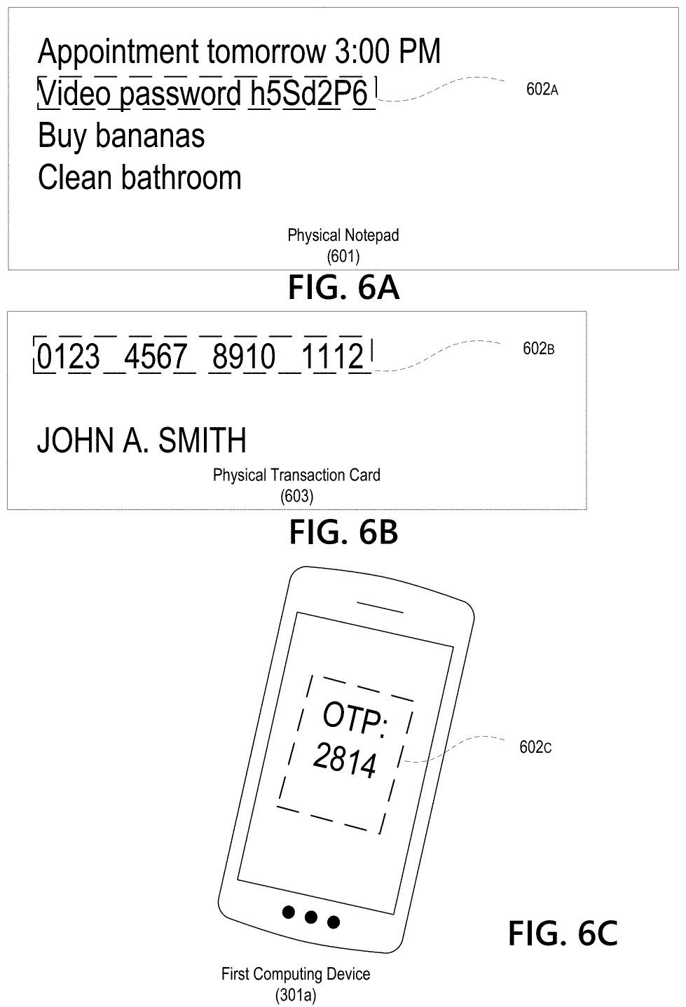

FIG. 6A depicts a physical notepad 601 with a password 602a written thereon. FIG. 6A thereby provides an example of a physical notepad (e.g., which may be the same or similar as the notepad 402) which may have content which, when imaged and processed in accordance with the steps discussed above with respect to FIG. 5, may be input into a user interface element (e.g., one requesting a password).

FIG. 6B depicts a physical transaction card 603 with a payment card number 602b written thereon. FIG. 6B thereby provides an example of a physical transaction card (e.g., which may be the same or similar as the payment card 401) which may have content which, when imaged and processed in accordance with the steps discussed above with respect to FIG. 5, may be input into a user interface element (e.g., one requesting a payment card number).

FIG. 6C depicts the first computing device 301a displaying a one-time password 602c on a display screen of the first computing device 301a. Such a one-time password may be displayed by the first computing device 301a via a text messaging application or similar messaging application as part of a two-factor authentication scheme. FIG. 6C thereby provides an example of a computing device displaying content which, when imaged and processed in accordance with the steps discussed above with respect to FIG. 5, may be input into a user interface element (e.g., one requesting a one-time password) on an entirely different computing device.

FIG. 7 depicts an example deep neural network architecture 700, which may be used to implement any of the machine learning models described with respect to the steps of, e.g., FIG. 5. The architecture depicted in FIG. 7 need not be performed on a single computing device, and may be performed by, e.g., a plurality of computers (e.g., any one of the devices depicted in FIG. 1 or FIG. 2). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 710, one or more hidden layers 720, and an output layer 730. A deep neural network, as used herein, may be an artificial network that has more than one hidden layer. Illustrated network architecture 700 is depicted with three hidden layers, and thus may be considered a deep neural network. The number of hidden layers employed in deep neural network 700 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

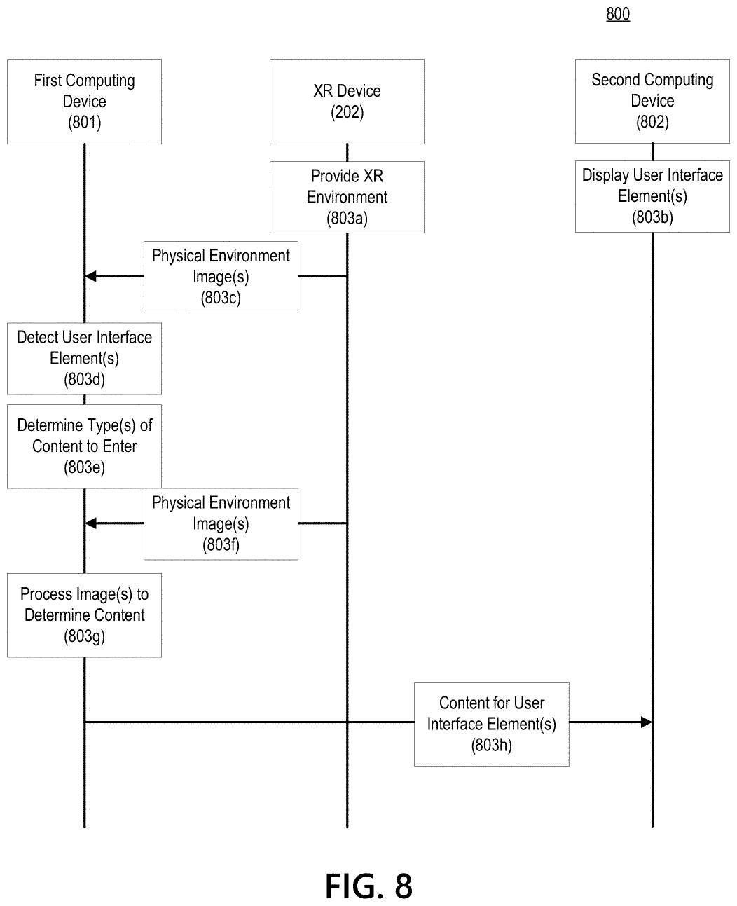

FIG. 8 depicts a messaging diagram 800 for providing content to user interface elements via an XR environment. FIG. 8 depicts an illustrative example where some aspects of processing are performed on a computing device separate from the XR device 202. Particularly, the messaging diagram 800 comprises a first computing device 801, a second computing device 802, and the XR device 202. With that said, for example, the XR device 202 and the first computing device 801 may be the same or similar computing devices. For example, the first computing device 801 may be the external computing device 204, such that the first computing device 801 and the XR device 202 may work in tandem to provide an XR environment (among other steps). The steps shown in FIG. 8 are illustrative, and the first computing device 801, the XR device 202, and/or the second computing device 802 may comprise all or portions of a computing device, such as the external computing device 204, the internal computing device 201, or the like. A computing device comprising one or more processors and memory storing instructions may be configured such that the instructions, when executed, cause performance of any of the steps depicted in FIG. 8. The steps depicted in FIG. 8 are illustrative, and may be rearranged or omitted as desired.

In step 803a, the XR device 202 may provide an XR environment. This step may be the same or similar as step 501 of FIG. 5.

In step 803b, the second computing device 802 may display one or more user interface elements on a display device. For example, the second computing device 802 may display an HTML form comprising one or more fields for entry.

In step 803c, the XR device 202 may send, to the first computing device 801, physical environment images. These images may comprise at least one image of a display device associated with the second computing device 802.

In step 803d, the first computing device 801 may detect one or more user interface elements. These detected user interface elements may be the user interface elements displayed, by the second computing device 802, in step 803b. This process may additionally and/or alternatively involve monitoring of web content, such as the HTML displayed by the second computing device 802. For example, a user might navigate to HTML content using a web browser of the second computing device 802. An event handler might then be called responsive to the detection of a web form in the HTML content. One or more user interface elements might then be detected based on processing (e.g., identification of fields, classification of those fields) of that HTML content.

Various computing devices may provide the XR device 202 information about user interface elements such that, for example, the XR device 202 may be provided information about the sort of user interface elements to look for. For example, as part of step 803c and/or step 803d, the first computing device 801 may provide, to the XR device 202, information about the type of content to image using the cameras 203d of the XR device 202. In this manner, the XR device 202 may better capture images of user interface elements displayed by other computing devices, such as the second computing device 802. For example, the first computing device 801 may provide the XR device 202 data indicating that the XR device 202 should look for substantially square regions corresponding to display devices such as televisions and computer monitors. As another example, the first computing device 801 may provide the XR device 202 data indicating that the XR device 202 should look for form fields of a particular shape (e.g., rectangular with borders). The first computing device 801 may provide, to the XR device 202, information about user interface elements predicted to be displayed by other computing devices. For example, if the second computing device 802 is a smartphone, then certain user interface elements (e.g., text boxes) might be displayed in a manner in accordance with a smartphone operating system (and, e.g., might be accompanied by an on-screen keyboard). In such a circumstance, the first computing device 801 might provide the XR device 202 data indicating, for example, what such user interface elements might look like (e.g., what colors and/or shapes to look for, roughly how large the display screen of the second computing device 802 is, etc.) when displayed in the smartphone operating system. The XR device 202 might use such data to attempt to identify such elements in images, captured by the cameras 203d, of a physical environment around the XR device 202. For example, if the first computing device 801 provides data to the XR device 202 indicating that user interface elements displayed by the second computing device 802 might be surrounded by a gray or white border, then the XR device 802 might be configured to capture images using its cameras responsive to detecting that a gray or white border is detected in the field of view of the cameras. In turn, this might add efficiency to the process depicted n step 803c: because the XR device 202 might better be instructed to capture images likely to contain user interface elements (and, e.g., not capture images that are unlikely to contain user interface elements), the quantity and/or frequency of images transmitted from the XR device 202 to the first computing device 801 might be lowered.

In step 803e, the first computing device 801 may determine one or more types of content to enter into the user interface elements detected in step 803d. This step may be the same or similar as step 504 of FIG. 5.

In step 803f, the XR device 202 may send physical environment images to the first computing device 801. These images may comprise at least one image of a physical object around the XR device 202.

In step 803g, the first computing device 801 may process the images received in step 803f to determine content. That content may be processed such that it may be provided to the user interface elements detected in step 803d. This step may be the same or similar as step 506 of FIG. 5.

In step 803h, the first computing device 801 may send, to the second computing device 802, the content, determined in step 803g, for entry into the user interface elements detected in step 803d. This step may be the same or similar as step 507 of FIG. 5.

The following paragraphs (M1) through (M10) describe examples of methods that may be implemented in accordance with the present disclosure.

(M1) A method comprising: providing, to a user, an XR environment; detecting, in a physical environment around the XR device, a user interface element, displayed by a display device, that permits entry of content by a user of a first computing device; determining, based on one or more properties of the user interface element, a type of content to be entered via the user interface element; receiving an image of a physical object, in the physical environment around the XR device, corresponding to the type of content to be entered via the user interface element; processing the image of the physical object to determine first content to provide to the user interface element; and transmitting, to the first computing device, the first content for entry into the user interface element.

(M2) A method may be performed as described in paragraph (M1) wherein receiving the image of the physical object comprises: training, using training data, a machine learning model to detect images of physical objects corresponding to the type of content in a plurality of different physical environments, wherein the training data comprises a plurality of different images of the physical objects; providing, to the trained machine learning model, one or more images corresponding to the physical environment; and receiving, as output from the trained machine learning model, the image of the physical object.

(M3) A method may be performed as described in paragraph (M1) or (M2) wherein processing the image of the physical object comprises: processing, using an optical character recognition algorithm, text in the image of the physical object, wherein the first content comprises at least a portion of the text in the image.

(M4) A method may be performed as described in any one of paragraphs (M1)-(M3) wherein receiving the image of the physical object comprises: capturing, via one or more cameras of the XR device, text displayed by a second display device of a second computing device.

(M5) A method may be performed as described in any one of paragraphs (M1)-(M4) wherein transmitting the first content comprises: transmitting, to the first computing device, data that causes the first computing device to automatically provide the first content to the user interface element.

(M6) A method may be performed as described in any one of paragraphs (M1)-(M5), wherein detecting the type of content to be entered via the user interface element comprises determining that the user interface element corresponds to entry of a payment card number, wherein the type of content comprises a string of numbers, and wherein the one or more properties of the user interface element comprise a label associated with the user interface element.

(M7) A method may be performed as described in any one of paragraphs (M1)-(M6) wherein detecting the type of content to be entered via the user interface element comprises determining that the user interface element corresponds to entry of a password, wherein the type of content comprises a string of characters, and wherein the one or more properties of the user interface element comprise a location of the user interface element.

(M8) A method may be performed as described in any one of paragraphs (M1)-(M7), wherein detecting the type of content to be entered via the user interface element comprises determining that the user interface element corresponds to entry of a one-time-use code, wherein the type of content comprises a string of characters, and wherein the image of the physical object indicates content displayed by a text messaging application.

(M9) A method may be performed as described in any one of paragraphs (M1)-(M8), further comprising: providing, via the XR environment, a second user interface element; and receiving, via the XR environment, user input corresponding to the second user interface element, wherein transmitting the first content is based on the user input.

(M10) A method may be performed as described in any one of paragraphs (M1)-(M9), wherein detecting the user interface element comprises capturing, using one or more cameras of the XR device, one or more images of the display device.

The following paragraphs (A1) through (A10) describe examples of apparatuses that may be implemented in accordance with the present disclosure.

(A1) An XR device comprising: one or more processors; and memory storing instructions that, when executed by the one or more processors, cause the XR device to: provide, via an extended reality (XR) device and to a user, an XR environment; detect, in a physical environment around the XR device, a user interface element, displayed by a display device, that permits entry of content by a user of a first computing device; determine, based on one or more properties of the user interface element, a type of content to be entered via the user interface element; receive an image of a physical object, in the physical environment around the XR device, corresponding to the type of content to be entered via the user interface element; process the image of the physical object to determine first content to provide to the user interface element; and transmit, to the first computing device, the first content for entry into the user interface element.

(A2) An XR device as described in paragraph (A1), wherein the instructions, when executed by the one or more processors, cause the XR device to receive the image of the physical object by causing the XR device to: train, using training data, a machine learning model to detect images of physical objects corresponding to the type of content in a plurality of different physical environments, wherein the training data comprises a plurality of different images of the physical objects; provide, to the trained machine learning model, one or more images corresponding to the physical environment; and receive, as output from the trained machine learning model, the image of the physical object.

(A3) An XR device as described in paragraph (A2), wherein the instructions, when executed by the one or more processors, cause the XR device to process the image of the physical object by causing the XR device to: process, using an optical character recognition algorithm, text in the image of the physical object, wherein the first content comprises at least a portion of the text in the image.

(A4) An XR device as described in any one of paragraphs (A1)-(A3), wherein the instructions, when executed by the one or more processors, cause the XR device to receive the image of the physical object by causing the XR device to: capture, via one or more cameras of the XR device, text displayed by a second display device of a second computing device.

(A5) An XR device as described in any one of paragraphs (A1)-(A4), wherein the instructions, when executed by the one or more processors, further cause the XR device to transmit the first content by causing the XR device to: transmit, to the first computing device, data that causes the first computing device to automatically provide the first content to the user interface element.

(A6) An XR device as described in any one of paragraphs (A1)-(A5), wherein the instructions, when executed by the one or more processors, cause the XR device to detect the type of content to be entered via the user interface element by causing the XR device to: determine that the user interface element corresponds to entry of a payment card number, wherein the type of content comprises a string of numbers, and wherein the one or more properties of the user interface element comprise a label associated with the user interface element.

(A7) An XR device as described in any one of paragraphs (A1)-(A6), wherein the instructions, when executed by the one or more processors, cause the XR device to detect the type of content to be entered via the user interface element by causing the XR device to: determine that the user interface element corresponds to entry of a password, wherein the type of content comprises a string of characters, and wherein the one or more properties of the user interface element comprise a location of the user interface element.

(A8) An XR device as described in any one of paragraphs (A1)-(A7), wherein the instructions, when executed by the one or more processors, cause the XR device to detect the type of content to be entered via the user interface element by causing the XR device to: determine that the user interface element corresponds to entry of a one-time-use code, wherein the type of content comprises a string of characters, and wherein the image of the physical object indicates content displayed by a text messaging application.

(A9) An XR device as described in any one of paragraphs (A1)-(A8), wherein the instructions, when executed by the one or more processors, further cause the XR device to: provide, via the XR environment, a second user interface element; and receive, via the XR environment, user input corresponding to the second user interface element, wherein the instructions, when executed by the one or more processors, cause the XR device to transmit the first content based on the user input.

(A10) An XR device as described in any one of paragraphs (A1)-(A9), wherein the instructions, when executed by the one or more processors, cause the XR device to detect the user interface element by causing the XR device to: capture, using one or more cameras of the XR device, one or more images of the display device.

The following paragraphs (CRM1) through (CRM10) describe examples of computer-readable media that may be implemented in accordance with the present disclosure.

(CRM1) One or more non-transitory computer-readable media storing instructions that, when executed by one or more processors of a computing device, cause the computing device to: provide, via an extended reality (XR) device and to a user, an XR environment; detect, in a physical environment around the XR device, a user interface element, displayed by a display device, that permits entry of content by a user of a first computing device; determine, based on one or more properties of the user interface element, a type of content to be entered via the user interface element; receive an image of a physical object, in the physical environment around the XR device, corresponding to the type of content to be entered via the user interface element; process the image of the physical object to determine first content to provide to the user interface element; and transmit, to the first computing device, the first content for entry into the user interface element.

(CRM2) One or more non-transitory computer-readable media as described in paragraph (CRM1), wherein the instructions, when executed by the one or more processors, cause the XR device to receive the image of the physical object by causing the XR device to: train, using training data, a machine learning model to detect images of physical objects corresponding to the type of content in a plurality of different physical environments, wherein the training data comprises a plurality of different images of the physical objects; provide, to the trained machine learning model, one or more images corresponding to the physical environment; and receive, as output from the trained machine learning model, the image of the physical object.

(CRM3) One or more non-transitory computer-readable media as described in paragraph (CRM2), wherein the instructions, when executed by the one or more processors, cause the XR device to process the image of the physical object by causing the XR device to: process, using an optical character recognition algorithm, text in the image of the physical object, wherein the first content comprises at least a portion of the text in the image.

(CRM4) One or more non-transitory computer-readable media as described in any one of paragraphs (CRM1)-(CRM3), wherein the instructions, when executed by the one or more processors, cause the XR device to receive the image of the physical object by causing the XR device to: capture, via one or more cameras of the XR device, text displayed by a second display device of a second computing device.

(CRM5) One or more non-transitory computer-readable media as described in any one of paragraphs (CRM1)-(CRM4), wherein the instructions, when executed by the one or more processors, further cause the XR device to transmit the first content by causing the XR device to: transmit, to the first computing device, data that causes the first computing device to automatically provide the first content to the user interface element.

(CRM6) One or more non-transitory computer-readable media as described in any one of paragraphs (CRM1)-(CRM5), wherein the instructions, when executed by the one or more processors, cause the XR device to detect the type of content to be entered via the user interface element by causing the XR device to: determine that the user interface element corresponds to entry of a payment card number, wherein the type of content comprises a string of numbers, and wherein the one or more properties of the user interface element comprise a label associated with the user interface element.

(CRM7) One or more non-transitory computer-readable media as described in any one of paragraphs (CRM1)-(CRM6), wherein the instructions, when executed by the one or more processors, cause the XR device to detect the type of content to be entered via the user interface element by causing the XR device to: determine that the user interface element corresponds to entry of a password, wherein the type of content comprises a string of characters, and wherein the one or more properties of the user interface element comprise a location of the user interface element.

(CRM8) One or more non-transitory computer-readable media as described in any one of paragraphs (CRM1)-(CRM7), wherein the instructions, when executed by the one or more processors, cause the XR device to detect the type of content to be entered via the user interface element by causing the XR device to: determine that the user interface element corresponds to entry of a one-time-use code, wherein the type of content comprises a string of characters, and wherein the image of the physical object indicates content displayed by a text messaging application.

(CRM9) One or more non-transitory computer-readable media as described in any one of paragraphs (CRM1)-(CRM8), wherein the instructions, when executed by the one or more processors, further cause the XR device to: provide, via the XR environment, a second user interface element; and receive, via the XR environment, user input corresponding to the second user interface element, wherein the instructions, when executed by the one or more processors, cause the XR device to transmit the first content based on the user input.

(CRM10) One or more non-transitory computer-readable media as described in any one of paragraphs (CRM1)-(CRM9), wherein the instructions, when executed by the one or more processors, cause the XR device to detect the user interface element by causing the XR device to: capture, using one or more cameras of the XR device, one or more images of the display device.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

What is claimed is:

1. An extended reality (XR) device comprising:
one or more processors; and
memory storing instructions that, when executed by the one or more processors, cause the XR device to:
provide, to a user, an XR environment;
detect, in a physical environment around the XR device, a user interface element, displayed by a display device, that permits entry of content by a user of a first computing device;
determine, based on one or more properties of the user interface element, a type of content to be entered via the user interface element;
receive an image of a physical object, in the physical environment around the XR device, corresponding to the type of content to be entered via the user interface element;
process the image of the physical object to determine first content to provide to the user interface element; and
transmit, to the first computing device, the first content for entry into the user interface element.

2. The XR device of claim 1, wherein the instructions, when executed by the one or more processors, cause the XR device to receive the image of the physical object by causing the XR device to:
train, using training data, a machine learning model to detect images of physical objects corresponding to the type of content in a plurality of different physical environments, wherein the training data comprises a plurality of different images of the physical objects;
provide, to the trained machine learning model, one or more images corresponding to the physical environment; and
receive, as output from the trained machine learning model, the image of the physical object.

3. The XR device of claim 1, wherein the instructions, when executed by the one or more processors, cause the XR device to process the image of the physical object by causing the XR device to:
process, using an optical character recognition algorithm, text in the image of the physical object, wherein the first content comprises at least a portion of the text in the image.

4. The XR device of claim 1, wherein the instructions, when executed by the one or more processors, cause the XR device to receive the image of the physical object by causing the XR device to:
capture, via one or more cameras of the XR device, text displayed by a second display device of a second computing device.

5. The XR device of claim 1, wherein the instructions, when executed by the one or more processors, further cause the XR device to transmit the first content by causing the XR device to:
transmit, to the first computing device, data that causes the first computing device to automatically provide the first content to the user interface element.

6. The XR device of claim 1, wherein the instructions, when executed by the one or more processors, cause the XR device to detect the type of content to be entered via the user interface element by causing the XR device to:
determine that the user interface element corresponds to entry of a payment card number, wherein the type of content comprises a string of numbers, and wherein the one or more properties of the user interface element comprise a label associated with the user interface element.

7. The XR device of claim 1, wherein the instructions, when executed by the one or more processors, cause the XR device to detect the type of content to be entered via the user interface element by causing the XR device to:
determine that the user interface element corresponds to entry of a password, wherein the type of content comprises a string of characters, and wherein the one or more properties of the user interface element comprise a location of the user interface element.

8. The XR device of claim 1, wherein the instructions, when executed by the one or more processors, cause the XR device to detect the type of content to be entered via the user interface element by causing the XR device to:
determine that the user interface element corresponds to entry of a one-time-use code, wherein the type of content comprises a string of characters, and wherein the image of the physical object indicates content displayed by a text messaging application.

9. The XR device of claim 1, wherein the instructions, when executed by the one or more processors, further cause the XR device to:
provide a second user interface element; and
receive user input corresponding to the second user interface element, wherein the instructions, when executed by the one or more processors, cause the XR device to transmit the first content based on the user input.

10. The XR device of claim 1, wherein the instructions, when executed by the one or more processors, cause the XR device to detect the user interface element by causing the XR device to:
capture, using one or more cameras of the XR device, one or more images of the display device.

11. A method comprising:
providing, to a user, an extended reality (XR) environment;
detecting, in a physical environment around the XR device, a user interface element, displayed by a display device, that permits entry of content by a user of a first computing device;
determining, based on one or more properties of the user interface element, a type of content to be entered via the user interface element;
receiving an image of a physical object, in the physical environment around the XR device, corresponding to the type of content to be entered via the user interface element;
processing the image of the physical object to determine first content to provide to the user interface element; and
transmitting, to the first computing device, the first content for entry into the user interface element.

12. The method of claim 11, wherein receiving the image of the physical object comprises:
training, using training data, a machine learning model to detect images of physical objects corresponding to the type of content in a plurality of different physical environments, wherein the training data comprises a plurality of different images of the physical objects;
providing, to the trained machine learning model, one or more images corresponding to the physical environment; and
receiving, as output from the trained machine learning model, the image of the physical object.

13. The method of claim 11, wherein processing the image of the physical object comprises:
processing, using an optical character recognition algorithm, text in the image of the physical object, wherein the first content comprises at least a portion of the text in the image.

14. The method of claim 11, wherein receiving the image of the physical object comprises:
capturing, via one or more cameras of the XR device, text displayed by a second display device of a second computing device.

15. The method of claim 11, wherein transmitting the first content comprises:
transmitting, to the first computing device, data that causes the first computing device to automatically provide the first content to the user interface element.

16. One or more non-transitory computer-readable media storing instructions that, when executed by one or more processors of an extended reality (XR) device, cause the XR device to:
provide, to a user, an XR environment;
detect, in a physical environment around the XR device, a user interface element, displayed by a display device, that permits entry of content by a user of a first computing device;
determine, based on one or more properties of the user interface element, a type of content to be entered via the user interface element;
receive an image of a physical object, in the physical environment around the XR device, corresponding to the type of content to be entered via the user interface element;
process the image of the physical object to determine first content to provide to the user interface element; and
transmit, to the first computing device, the first content for entry into the user interface element.

17. The non-transitory computer-readable media of claim 16, wherein the instructions, when executed by the one or more processors, cause the XR device to receive the image of the physical object by causing the XR device to:
train, using training data, a machine learning model to detect images of physical objects corresponding to the type of content in a plurality of different physical environments, wherein the training data comprises a plurality of different images of the physical objects;
provide, to the trained machine learning model, one or more images corresponding to the physical environment; and
receive, as output from the trained machine learning model, the image of the physical object.

18. The non-transitory computer-readable media of claim 16, wherein the instructions, when executed by the one or more processors, cause the XR device to process the image of the physical object by causing the XR device to:
process, using an optical character recognition algorithm, text in the image of the physical object, wherein the first content comprises at least a portion of the text in the image.

19. The non-transitory computer-readable media of claim 16, wherein the instructions, when executed by the one or more processors, cause the XR device to receive the image of the physical object by causing the XR device to:
capture, via one or more cameras of the XR device, text displayed by a second display device of a second computing device.

20. The non-transitory computer-readable media of claim 16, wherein the instructions, when executed by the one or more processors, further cause the XR device to transmit the first content by causing the XR device to:
transmit, to the first computing device, data that causes the first computing device to automatically provide the first content to the user interface element.
